(19) United States
(12) Patent Application Publication
(10) Pub. No.: US 2022/0258176 A1
(43) Pub. Date: Aug. 18, 2022

(54) INTELLIGENT CONTROL METHOD FOR DRY DENSE MEDIUM FLUIDIZED BED SEPARATOR

(71) Applicant: CHINA UNIVERSITY OF MINING AND TECHNOLOGY, Jiangsu (CN)

(72) Inventors: Liang DONG, Jiangsu (CN); Yuemin ZHAO, Jiangsu (CN); Yongxin REN, Jiangsu (CN); Guanghui WANG, Jiangsu (CN); Wei DAI, Jiangsu (CN); Enhui ZHOU, Jiangsu (CN); Chenlong DUAN, Jiangsu (CN); Yanjiao LI, Jiangsu (CN)

(73) Assignee: CHINA UNIVERSITY OF MINING AND TECHNOLOGY, Jiangsu (CN)

(21) Appl. No.: 17/432,486

(22) PCT Filed: Jun. 22, 2020
(86) PCT No.: PCT/CN2020/097386

§ 371 Date: Aug. 19, 2021

(30) Foreign Application Priority Data
Apr. 20, 2020 (CN) 202010311220.1

(51) Int. Cl. B03B 13/04; B03B 4/06; B03B 5/46

(52) U.S. Cl. CPC B03B 13/04; B03B 5/46; B03B 4/06

(57) ABSTRACT

An intelligent control method for a dry dense medium fluidized bed separator includes supplying air to fluidize a bed; estimating an initial bed density according to a washability curve of a raw coal; detecting a magnetic material content in the bed to obtain a real-time bed density, and adjusting the real-time bed density according to a result from an analysis on a deviation from the initial bed density; during separation, adjusting a medium addition amount and a scraper discharge speed to maintain a stability of a bed height; separating the raw coal in the dry dense medium fluidized bed separator to obtain a clean coal product; and detecting a product ash content of the clean coal product, comparing the product ash content with a target ash content, and if a difference between the product ash content and the target ash content exceeds an expectation, adjusting the initial bed density.

### BACKGROUND

### Technical Field

The present invention belongs to the technical field of coal separation with dry dense medium fluidized beds, and in particular, relates to an intelligent control method for a dry dense medium fluidized bed separator.

### Description of Related Art

A dry dense medium fluidized bed is an efficient dry separation technology that applies a gas-solid fluidization technology to the field of coal separation. In this technology, a fine particle material (such as magnetite powder) is used as a dense medium bed, and under the action of a uniform updraft, a gas-solid two-phase suspension with a certain density and height is formed. Coal particles entering the separator are stratified according to density in the bed, where clean coal floats on the surface of the bed, and gangue sinks at the bottom of the bed, thereby realizing the separation of coal.

The key to the coal separation with the dry dense medium fluidized bed lies in a bed density of the fluidized bed. During the separation, raw coal may bring in fine-grained slime, and a certain amount of secondary slime may be produced during the separation. The fine-grained slime in the fluidized bed can broaden particle size distribution of particles in the bed, and have a similar effect as a lubricant, which helps to improve the quality of fluidization. However, the presence of too much fine-grained slime in the fluidized bed will reduce the bed density, and is not conducive to the uniformity and stability of the bed density. This requires monitoring on the bed density and timely replenishment of the high-density magnetite powder to maintain the uniform and stable bed density.

The bed height is also one of important factors that affect the effect of coal separation with the dry dense medium fluidized bed. An air flow enters the bed in the form of microbubbles through an air distribution plate, and the bubbles will merge and become larger during ascending. A higher bed and larger bubbles result in a stronger disturbing effect on the bed, which is not conducive to the stability of the bed. In addition, when the bed is too high, the time for settlement of heavy products in the bed is long, which will affect the separation effect. When the bed is too low, light products will be lower than a conveying scraper and cannot be discharged, which will affect the separation process. Therefore, the bed height of the fluidized bed is an important parameter and must be controlled within an appropriate range.

In order for the coal separation process with the dry dense medium fluidized bed to proceed normally, it is necessary to ensure that the height and density of the bed are uniform and stable. At present, an automatic control system of a dry dense medium fluidized bed separator measures the density and height of a bed, and inputs an obtained measurement signal into a computer for analysis and processing. The computer adopts a control method, and outputs an adjustment signal to a regulator to adjust the destiny and height of the bed. This method has a high measurement accuracy and convenient operation and use, and realizes the automatic control of the density and height of the dry dense medium fluidized bed separator. However, the method still has problems. First, disturbance of an air flow, movement of bubbles, collision of particles, and other interference factors will cause fluctuations of a bed pressure, and as the bed pressure is unstable, a pressure drop signal detected by a sensor is constantly changing. Second, it lacks necessary monitoring on properties of raw coal and properties of products after separation.

### SUMMARY

Purpose of the present invention: In view of the above problems, the present invention proposes an intelligent control method for a dry dense medium fluidized bed separator to solve the problem of low degree of intelligent control in the current production and improve the quality of coal separation.

Technical solution: In order to achieve the purpose of the present invention, the following technical solution is adopted by the present invention. An intelligent control method for a dry dense medium fluidized bed separator, including the following steps:

step 1: controlling a fan to blow an air flow into a bed body to fluidize a bed, when a fluctuation of a pressure drop of the bed becomes stable, controlling an air pressure and an air volume to maintain stability; and estimating an initial bed density Dₑ⁰ according to a washability curve of a selected raw coal;

step 2: detecting a magnetic material content in the bed, calculating a real-time bed density Dₑ^{t}, comparing the real bed density Dₑ^{t} with the initial bed density Dₑ⁰, adjusting a medium addition valve according to a result from the comparing, and adding a medium to the dry dense medium fluidized bed separator;

step 3: controlling and adjusting a scraper discharge speed and a medium addition amount to maintain a stability of a bed height; and separating the selected raw coal in the dry dense medium fluidized bed separator to obtain a clean coal product; and

step 4: detecting, in real time, a product ash content of the clean coal product obtained by the separating, and comparing the product ash content with a target ash content of the clean coal product; and if a difference between the product ash content and the target ash content exceeds an expectation, adjusting the initial bed density.

Further, in the step 2, the adjusting of the medium addition valve according to the result from the comparing of the real-time bed density with the initial bed density, and the adding of the medium to the dry dense medium fluidized bed separator is specifically performed by

calculating a deviation D₁=|ρₑ^{t}−ρₑ⁰| of the real-time bed density ρₑ^{t} from the initial bed density ρₑ⁰,

wherein if D₁≤A₁, it indicates that the deviation meets an expectation, the real-time bed density is not adjusted, wherein A₁ is a density deviation threshold;

if D₁>A₁ and ρₑ^{t}>ρₑ⁰, a circulating medium is added to the dry dense medium fluidized bed separator to reduce the real-time bed density;

if D₁>A₁ and ρₑ^{t}<ρₑ⁰, a magnetite powder is added to the dry dense medium fluidized bed separator to increase the real-time bed density; and

the circulating medium is a magnetite powder mixture containing a fine-grained coal slime, which is discharged with a separation product and has not been magnetically separated.

Further, in the step 3, the controlling and adjusting of the scraper discharge speed and the medium addition amount to maintain the stability of the bed height is specifically performed by

acquiring a real-time bed height Hₜ, and calculating a deviation D₂=|Hₜ−H₀| of the real-time bed height Hₜ from a set height H₀,

wherein if D₂≤A₂ it indicates that the deviation meets an expectation, the bed height is not adjusted, wherein A₂ is a height deviation threshold;

if D₂>A₂ and Hₜ>H₀, the scraper discharge speed is increased and meanwhile the medium addition amount is reduced to reduce the bed height; and

if D₂>A₂ and Hₜ<H₀, the scraper discharge speed is reduced and meanwhile the medium addition amount is increased to increase the bed height.

Further, in the step 4, the comparing of the product ash content detected in real time with the target ash content of the clean coal product, and the adjusting of the initial bed density according to a result from the comparing is specifically performed by

calculating a deviation D₃=|Adₜ−Ad₀| of the product ash content Adₜ detected in real time from the target ash content Ad₀ of the clean coal product,

wherein if D₃≤A₃ it indicates that the deviation meets the expectation, the initial bed density is not adjusted, wherein A₃ is an ash content deviation threshold;

if D₃>A₃ and Adₜ>Ad₀ the initial bed density is reduced, that is, an amount of the circulating medium added is increased and an amount of the magnetite powder added is reduced; and if D₃>A₃ and Adₜ<Ad₀ the initial bed density is increased, that is, the amount of the magnetite powder added is increased and the amount of the circulating medium added is reduced.

Beneficial effects: Compared with the prior art, the technical solution of the present invention has the following beneficial technical effects:

The intelligent control method for the dry dense medium fluidized bed separator of the present invention can detect and adjust the magnetic material content in the bed in real time to ensure the separation density. The medium addition amount and the scraper discharge speed can be adjusted in time to maintain the stable bed height in the separation process. The separation density is adjusted according to properties of the raw coal and the product to form two closed-loop automatic control systems, one is a feedforward system that adjusts coal separation parameters according to the properties of the raw coal, and the other is a feedback system that adjusts coal separation parameters according to the properties of the clean coal product, and thus the present invention has an advantage of high degree of intelligence.

### BRIEF DESCRIPTION OF THE DRAWINGS

FIG. 1 is a flowchart of intelligent control of a dry dense medium fluidized bed separator.

### DESCRIPTION OF THE EMBODIMENTS

The technical solution of the present invention will be further described below with reference to the accompanying drawings and embodiments.

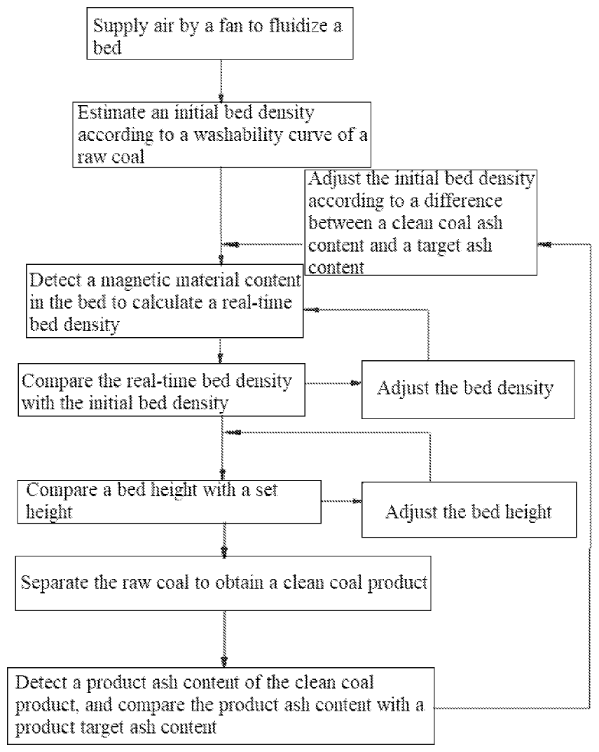

The process of an intelligent control method for a dry dense medium fluidized bed separator according to the present invention is shown in FIG. 1, including the following steps.

In step 1, a fan is controlled to blow an air flow into a bed body to fluidize the bed, when a fluctuation of a pressure drop of the bed becomes stable, an air pressure and an air volume are controlled to maintain stability, and a separation density, i.e., an initial bed density Dₑ⁰, is estimated according to a washability curve of a selected raw coal.

In step 2, a magnetic material content in the bed is measured through a magnetic material content detector, a real-time bed density Dₑ^{t} is calculated and compared with the initial bed density Dₑ⁰, a medium addition valve is adjusted according to a result from the comparing, and a medium is added to the separator so that a deviation of the real-time bed density from the initial bed density meets an expectation. Details are described as follows.

A deviation D₁=|ρₑ^{t}−ρₑ⁰| of the real-time bed density P: from the initial bed density ρₑ⁰ is calculated, wherein if D₁≤A₁, it indicates that the deviation meets an expectation, the bed density is not adjusted, and A₁ is a density deviation threshold; if D₁>A₁ and ρₑ^{t}>ρₑ⁰, a circulating medium is added to the separator to reduce the bed density; if D₁>A₁ and ρₑ^{t}<ρₑ⁰, magnetite powder is added to the separator to increase the bed density; and the circulating medium is a magnetite powder mixture containing fine-grained coal slime which is discharged with a separation product and has not been magnetically separated, and since the fine-grained coal slime is mixed therein, the circulating medium has a low density and can be used to adjust the bed density.

In step 3, during the separation, accumulation of coal slime content will reduce the bed density, and therefore, high-density magnetite powder may be added to the separator. After the magnetite powder is added, a bed height is changed, a scraper discharge speed and a medium addition amount are controlled and adjusted to maintain the stability of the bed height. The raw coal is separated in the separator to obtain a clean coal product. Details are described as follows.

A real-time bed height Hₜ is acquired, and a deviation D₂=|Hₜ−H₀< of the bed height Hₜ from a set height H₀ is calculated, wherein if D₂≤A₂, it indicates that the deviation meets an expectation, the bed height is not adjusted, and A₂ is a height deviation threshold; if D₂>A₂ and Hₜ>H₀, the scraper discharge speed is increased and the medium addition amount is reduced at the same time to reduce the bed height; and if D₂>A₂ and Hₜ<H₀, the scraper discharge speed is reduced and the medium addition amount is increased at the same time to increase the bed height.

In step 4, a product ash content of the clean coal product obtained by the separation is detected in real time through an online ash content tester on a clean coal conveying belt, and compared with a target ash content of the clean coal product. If a difference between the product ash content and the target ash content exceeds an expectation, the initial bed density is adjusted. Details are described as follows.

A deviation D₃=|Adₜ−Ad₀| of the real-time clean coal product ash content Adₜ from the target ash content Ad₀ of the clean coal product is calculated, wherein if D₃≤A₃ it indicates that the deviation meets an expectation, the initial bed density is not adjusted, and A₃ is an ash content deviation threshold; if D₃>A₃ and Adₜ>Ad₀, the initial bed density is reduced, that is, the addition amount of the circulating medium is increased and the addition amount of the magnetite powder is reduced; and if D₃>A₃ and Adₜ<Ad₀, the initial bed density is increased, that is, the addition amount of the magnetite powder is increased and the addition amount of the circulating medium is reduced.

The above are the preferred embodiments of the present invention. It should be pointed out that for those of ordinary skill in the art, several improvements and modifications can be made without departing from the technical principles of the present invention, and these improvements and modifications should be regarded as the protection scope of the present invention.

1. An intelligent control method for a dry dense medium fluidized bed separator, comprising the following steps:
step 1: controlling a fan to blow an air flow into a bed body to fluidize a bed, when a fluctuation of a pressure drop of the bed becomes stable, controlling an air pressure and an air volume to maintain stability; and estimating an initial bed density ρₑ⁰ according to a washability curve of a selected raw coal;
step 2: detecting a magnetic material content in the bed, calculating a real-time bed density ρₑ^{t}, comparing the real-time bed density ρₑ^{t} with the initial bed density ρₑ⁰, adjusting a medium addition valve according to a result from the comparing, and adding a medium to the dry dense medium fluidized bed separator;
calculating a deviation D₁=|ρₑ^{t}−ρₑ⁰| of the real-time bed density ρₑ^{t} from the initial) bed density ρₑ⁰,
wherein if D₁≤A₁, it indicates that the deviation meets an expectation, the real-time bed density is not adjusted, wherein A₁ is a density deviation threshold;
if D₁>A₁ and ρₑ^{t}>ρₑ⁰, a circulating medium is added to the dry dense medium fluidized bed separator to reduce the real-time bed density;
if D₁>A₁ and ρₑ^{t}<ρₑ⁰, a magnetite powder is added to the dry dense medium fluidized bed separator to increase the real-time bed density; and
the circulating medium is a magnetite powder mixture containing a fine-grained coal slime, which is discharged with a separation product and has not been magnetically separated;
step 3: controlling and adjusting a scraper discharge speed and a medium addition amount to maintain a stability of a bed height; and separating the selected raw coal in the dry dense medium fluidized bed separator to obtain a clean coal product;
acquiring a real-time bed height Hₜ, and calculating a deviation D₂=|Hₜ−H₀| of the real-time bed height Hₜ from a set height H₀,
wherein if D₂≤A₂, it indicates that the deviation meets an expectation, the bed height is not adjusted, wherein A₂ is a height deviation threshold;
if D₂>A₂ and Hₜ>H₀, the scraper discharge speed is increased and meanwhile the medium addition amount is reduced to reduce the bed height; and
if D₂>A₂ and Hₜ<H₀, the scraper discharge speed is reduced and meanwhile the medium addition amount is increased to increase the bed height; and
step 4: detecting, in real time, a product ash content of the clean coal product obtained by the separating, and comparing the product ash content with a target ash content of the clean coal product; and if a difference between the product ash content and the target ash content exceeds an expectation, adjusting the initial bed density;
calculating a deviation D₃=|Adₜ−Ad₀| of the product ash content Adₜ detected in real time from the target ash content Ad₀ of the clean coal product,
wherein if D₃≤A₃, it indicates that the deviation meets the expectation, the initial bed density is not adjusted, wherein A₃ is an ash content deviation threshold;
if D₃>A₃ and Adₜ>Ad₀, and the initial bed density is reduced, that is, an amount of a circulating medium added is increased and an amount of a magnetite powder added is reduced; if D₃>A₃ and Adₜ<Ad₀, and the initial bed density is increased, that is, the amount of the magnetite powder added is increased and the amount of the circulating medium added is reduced; and the circulating medium is a magnetite powder mixture containing a fine-grained coal slime, which is discharged with a separation product and has not been magnetically separated.

2-4. (canceled)
